(19) United States
(12) Patent Application Publication
(10) Pub. No.: US 2017/0031119 A1
(43) Pub. Date: Feb. 2, 2017

(54) INTEGRATED OPTIC FIBER ELECTRICAL CONNECTOR

(71) Applicant: Tyson York Winarski, Mountain View, CA (US)

(72) Inventor: Tyson York Winarski, Mountain View, CA (US)

(21) Appl. No.: 14/818,279

(22) Filed: Aug. 4, 2015

Related U.S. Application Data
(60) Provisional application No. 62/200,034, filed on Aug. 2, 2015.

(51) Int. Cl. G02B 6/42; G02B 6/38

(52) U.S. Cl. CPC G02B 6/4284; G02B 6/3817; G02B 6/4253; G02B 6/4292

(57) ABSTRACT

An optical fiber cable that has a connector housing that includes embedded optoelectronics, thereby making an electrical connection with a connectable device instead of an optical one.

This application claims the benefit of Provisional Patent Application 62/200,034 filed on Aug. 2, 2015, which is also hereby incorporated by reference.

### BACKGROUND

Fiber optic cables are favored for modern data communication. Fiber optic cable offers large bandwidth for high-speed data transmission. Signals can be sent farther than across copper cables without the need to “refresh” or strengthen the signal. Fiber optic cables offer superior resistance to electromagnetic noise, such as from adjoining cables. In addition, fiber optic cables require far less maintenance than metal cables, thereby making fiber optic cables more cost effective.

Optical fiber is made of a core that is surrounded by a cladding layer. The core is the physical medium that transports optical data signals from an attached light source to a receiving device. The core is a single continuous strand of glass or plastic that is measured (in microns) by the size of its outer diameter. The larger the core, the more light the cable can carry. All fiber optic cable is sized according to its core diameter. The three sizes most commonly available are 50-micron, 62.5-micron, and 100-micron cable. The cladding is a thin layer that surrounds the fiber core and serves as a boundary that contains the light waves and causes the refraction, enabling data to travel throughout the length of the fiber segment. Typically, the core and cladding are made of high-purity silica glass. The light signals remain within the optical fiber core due to total internal reflection within the core, which is caused by the difference in the refractive index between the cladding and the core.

The cladding is typically coated with a layer of acrylate polymer or polymide, thereby forming an insulating jacket. This insulating jacket protects the optic fiber from damage. This coating also reinforces the optic fiber core, absorbs mechanical shocks, and provides extra protection against excessive cable bends. These insulating jacket coatings are measured in microns and typically range from 250 microns to 900 microns.

Strengthening fibers are then commonly wrapped around the insulating jacket. These fibers help protect the core from crushing forces and excessive tension during installation. The strengthening fibers can be made of Kevlar for example.

An outer cable jacket is then provided as the outer layer of the cable. The outer cable jacket surrounds the strengthening fibers, the insulating jacket, the cladding and the optic fiber core. Typically, the outer cable jacket is colored orange, black, or yellow.

A fiber optic communications network includes a multitude of fiber optic connections. At these connections, the ends of two different fiber optic cables are coupled together to facilitate the transmission of light between them. At these ends of the fiber optic cables, the optic fiber core and cladding is exposed to the environment. When the ends of the optic fiber core and cladding are free of damage, dirt, or debris, light is transmitted cleanly between the two fiber optic cables. However, if either of the fiber optic cable ends has damage to the optic fiber core or cladding, the damage can prevent the transmission of light, causing back reflection, insertion loss, and damage to other network components. Typically, most fiber optic connectors are not inspected for damage until after a transmission problem is detected, which is often after permanent damage has been caused to other fiber optic equipment.

It is therefore desirable to develop technologies that can prevent damage to the ends of fiber optic cable to ensure the clean transmission of light signals at connections between different fiber optic cables.

### SUMMARY

An optical fiber cable is disclosed that has an optic fiber and a coupler housing configured to detachably mate mechanically with a conventional electronic device. The cable also has an optoelectronic circuit embedded within the coupler housing. The optoelectronic circuit sends or receives optical signals via the optic fiber. The optoelectronic circuit is configured to detachably mate electrically with a conventional electronic device.

The optoelectronic circuit is fixed to the optic fiber cable and cannot be detached. An end of the optic fiber has an optical connection with the optoelectronic circuit. The end of the optic fiber is encapsulated within the coupler housing. The optoelectronic circuit is encapsulated within the coupler housing. A controller is electrically connected to the optoelectronic circuit. A pair of electrical connectors is configured to detachably mate electrically with a conventional electronic device. The pair of electrical connectors are connected to the controller. The optic fiber extending from the coupler housing has a rear cable connector that is configured to mate with an optical fiber cable. The optical fiber cable sends optical signals into the optic fiber, which are then converted to electrical signals by the optoelectronic circuit, which are then transmitted into a conventional electronic device.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings, wherein:

FIG. 1 illustrates a PRIOR ART optical fiber cable and connector optically coupling with a conventional electronic device that communicates via optical fiber cables;

FIG. 2 illustrates an optical fiber cable that has an optoelectronic circuit embedded within the optical fiber connector electrically connecting with a conventional electronic device;

FIG. 3 illustrates a perspective view of an exterior of an integrated optical fiber cable and connector that has an optoelectronic circuit embedded within the optical fiber connector;

FIG. 4 illustrates a perspective view of an exterior of an integrated optical fiber cable and connector that has an optoelectronic circuit embedded within the optical fiber connector; and

FIG. 5 illustrates a perspective view of an exterior of an integrated optical fiber cable and connector that has an optoelectronic circuit embedded within the optical fiber connector housing where there is a rear cable connector for connecting to a conventional optical fiber cable.

### DETAILED DESCRIPTION

While the invention has been shown and described with reference to a particular embodiment thereof, it will be understood to those skilled in the art, that various changes in form and details may be made therein without departing from the spirit and scope of the invention.

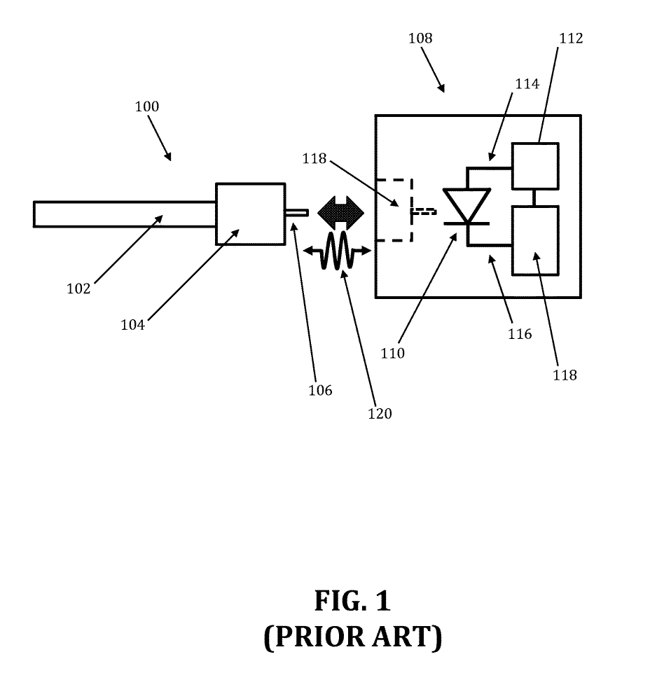

FIG. 1 illustrates a PRIOR ART optical fiber cable 100 and connector optically coupling with a conventional electronic device 108 that communicates via optical fiber cables 100. Optical fiber cable 100 includes a length of optic fiber cable 102, a coupler 104, and an exposed optic fiber end 106. Optical fiber cable 100 is a conventional optical fiber cable that includes an optic fiber surrounded by cladding, which is then covered with a layer of acrylate polymer or polymide, thereby forming an insulating jacket. Exposed optic fiber end 106 is configured to couple with a conventional electronic device 108 to facilitate optical communications. Conventional electronic device 108 includes an optoelectronic component 110, which is either a photodiode to emit optic signals or a photodetector to detect optic signals. Device 108 includes a controller circuit 112 for controlling the operation of optoelectronic component 110, and a computer system 118 that controls the operation of device 108. Electrical connections 114 and 116 connect optoelectronic component 110 to circuit 112 and system 118.

A significant problem with the PRIOR ART system illustrated in FIG. 1 is the fact that the connection made between fiber optic cable 100 and device 108 is an optical one that involves mechanically operating exposed optic fiber end 106. Connecting and disconnecting optic fiber cable 100 from device 108 risks damaging exposed optic fiber end 106. Chips, scratches, and other mechanical damage can occur on the surface of exposed optic fiber end 106 while it is being connected and disconnected with device 108 (as indicated with the bidirectional black arrow). In the PRIOR ART system of FIG. 1, optoelectronic circuit 110 that sends or receives optic signals via optic fiber cable 100 is separate and detachable from optic fiber cable 100. When cable 100 is removed from or attached to device 108, it is an optical connection 120 that is broken or connected.

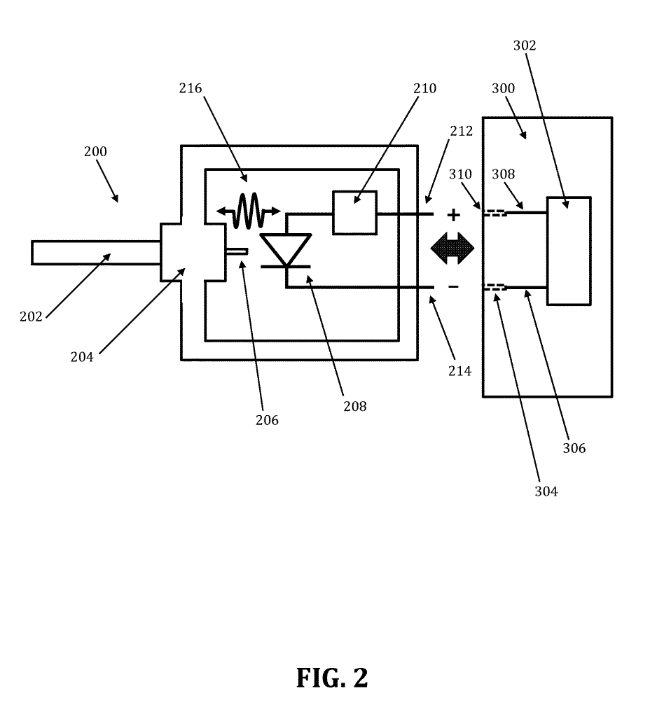

FIG. 2 illustrates an optical fiber cable 200 that has an optoelectronic circuit embedded 208 within the optical fiber connector 204 electrically connecting with a conventional electronic device 300. Optical fiber cable 200 includes a length of fiber cable having an optic fiber surrounded by cladding and an insulating jacket. Optic fiber cable 200 includes a connector housing 204 that houses optoelectronic circuit 208 and optoelectronic circuit controller 210. Electrical connectors 212 and 214 extend through housing 204 to make electrical contact with conventional electronic device 300. Optoelectronic circuit 208 and optoelectronic circuit controller 210 is completing housed and embedded within housing 204, thereby making optoelectronic circuit 208 and optoelectronic circuit controller 210 fixed integral parts of optic fiber cable that cannot be removed or detached from optic fiber cable 200. Optic fiber cable 200 makes an electrical connection with electronic device 300 via electrical connectors 212 and 214. Optical fiber cable 200 does not make an optical connection with device 300 due to the fact that optoelectronic circuit 208 is embedded within cable housing 204.

Optoelectronic circuit 208 may be a photodiode, a light-emitting diode, an organic light-emitting diode, a quantum-dot light-emitting diode, a light-emitting electrochemical cell, a laser, or other optoelectronic device configured to emit an optical signal to be carried by optic fiber 206. Optoelectronic circuit 208 may alternatively be a photodetector configured to receive an optical signal carried by optic fiber 206. Controller 210 controls the operation of optoelectronic circuit 208.

Conventional electronic device 300 includes electrical connectors 304 and 310 that mate with electrical connectors 212 and 214. Electrical connections 306 and 308 couple electrical connectors 304 and 310 to device electronic computer system 302. Optical fiber cable 200 is detachable and reattachable from device 300 (as indicated by the bidirectional black arrow). When optic fiber cable 200 is removed and reattached with device 300, exposed fiber end 206 is never exposed to mechanical damage as it is contained entirely within housing 204. When optic fiber cable 200 is removed and reattached with device 300, it is the electrical connection with electrical connectors 212 and 214 that is broken and reconnected. Thus, by permanently integrating optoelectronic circuit 208 within optic fiber housing 204 and making the detachable connection between cable 200 and device 300 an electrical one instead of an optical one with the PRIOR ART, cable 200 protects fiber end 206 from scratches and damage. Scratches and damage on cable fiber end 206 can degrade the signal carrying capacity of cable 200, if not permanently ruin the ability of cable 200 to function.

Optical fiber cable 200 has an optic fiber 202 and a coupler housing 204 configured to detachably mate mechanically with a conventional electronic device 300. The cable 200 also has an optoelectronic circuit 208 embedded within the coupler housing 204. The optoelectronic circuit 208 sends or receives optical signals 216 via the optic fiber 206. The optoelectronic circuit 208 is configured to detachably mate electrically with a conventional electronic device 300.

The optoelectronic circuit 208 is fixed to the optic fiber cable 200 and cannot be detached. An end 206 of the optic fiber 200 has an optical connection 216 with the optoelectronic circuit 208. The end 206 of the optic fiber 200 is encapsulated within the coupler housing 204. The optoelectronic circuit 208 is encapsulated within the coupler housing 204. A controller 210 is electrically connected to the optoelectronic circuit 208. A pair of electrical connectors 212 and 214 is configured to detachably mate electrically with a conventional electronic device 300. The pair of electrical connectors 212 and 214 are connected to the controller 210.

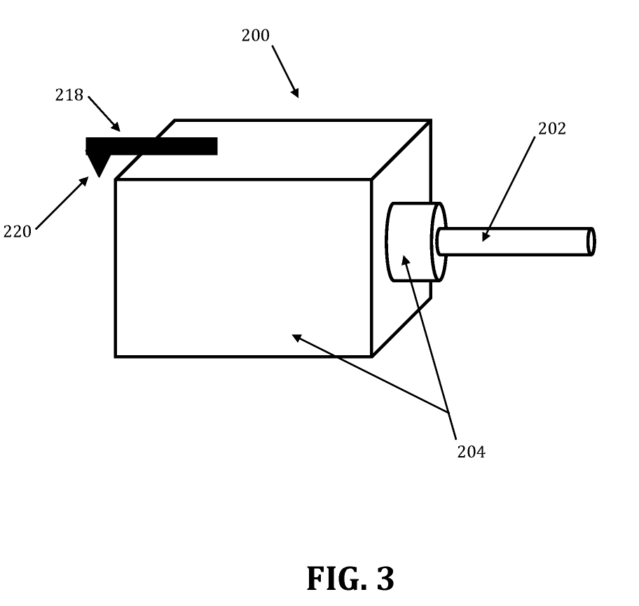

FIG. 3 illustrates a perspective view of an exterior of an integrated optical fiber cable and connector 200 that has an optoelectronic circuit 208 embedded within the optical fiber connector 204. Housing 204 forms a contiguous body capsule that encapsulates circuit 208, controller 210 and optic fiber end 206. By forming a contiguous housing, connector housing 204 prevents optic fiber end 206 from being exposed to the external environment and potential damage. Cable connector 200 includes a mechanical latch 218 that has a latching protrusion 220. Latch 218 and protrusion 220 mate with a corresponding latch receptor on device 300 to detachably lock cable connector 200 to device 300.

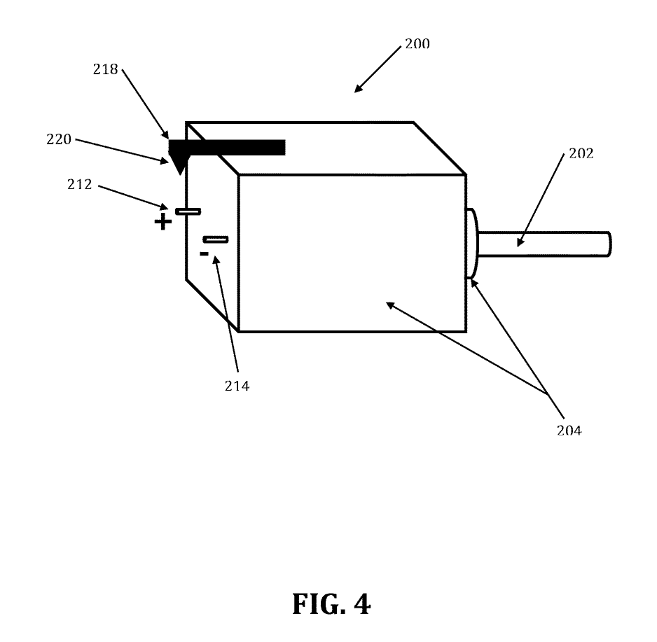

FIG. 4 illustrates a perspective view of an exterior of an integrated optical fiber cable and connector 200 that has an optoelectronic circuit 208 embedded within the optical fiber connector 204. Housing 204 forms a contiguous body capsule that encapsulates circuit 208, controller 210 and optic fiber end 206. By forming a contiguous housing, connector housing 204 prevents optic fiber end 206 from being exposed to the external environment and potential damage. Fiber connector 200 forms an electrical connection with device 300 using electrical contacts 212 and 214. Latch mechanism 218/220 mechanically secures fiber connector 200 to device 300 in a detachable manner. Latch mechanism is secured to housing 204 in such a way that it can partially move in a cantilever manner so that protrusion 220 can mate with and engage a corresponding structure on device 300. The configuration of electrical connections 212 and 214 are merely exemplary. Connections 212 and 214 may take the form of any conventional electrical connection such as a coaxial configuration for example. The configuration of latch 218 and 220 is merely exemplary. Any form of mechanical mechanism that can secure connector 200 to device 300 may be used.

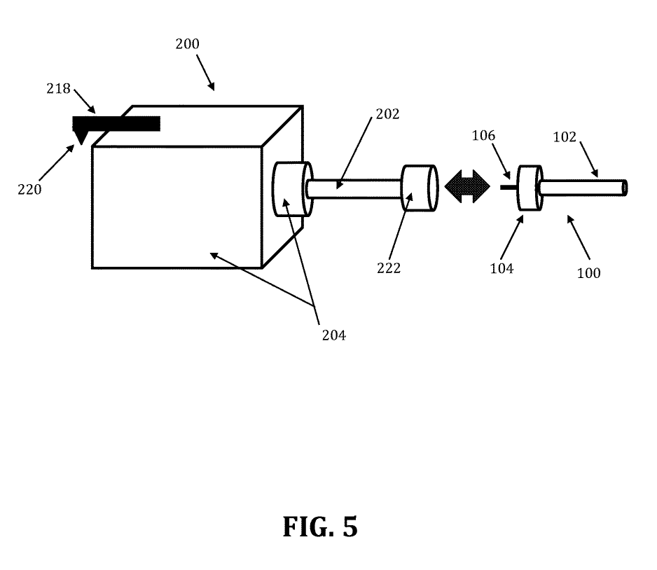

FIG. 5 illustrates a perspective view of an exterior of an integrated optical fiber cable and connector 200 that has an optoelectronic circuit 208 embedded within the optical fiber connector housing 204 where there is a rear cable connector 222 for connecting to a conventional optical fiber cable 100. Conventional optical fiber cable 100 includes a length of optic fiber cable 102, a coupler 104, and an exposed optic fiber end 106. Fiber cable connector includes a rear cable connector 222 that can mechanically couple with coupler 104 to connect cable 100 to cable connector 200. When cable 100 is connected to cable connector 200, cable 100 is able to send optical signals into cable connector 200, where they are converted to electrical signals by circuitry 108 and 110, and are then transmitted as electrical signals to device 300. With cable connector 200 attached to cable 100, exposed fiber end 104 only needs to be connected to cable connector once, thereby minimizing the potential for mechanical damage to exposed fiber end 104. However, cable connector 200 can then be attached and reattached numerous times to device 300 without risking mechanical damage to fiber end 106 or fiber end 206. Electrical connectors 212 and 214 are far more robust at withstanding repeated mechanical connections and disconnections without any loss in the ability to transmit electrical signals. Optic fiber 202 extending from coupler housing 204 has a rear cable connector 222 that is configured to mate with an optical fiber cable 100. Optical fiber cable 100 sends optical signals into optic fiber 202, which are then converted to electrical signals by the optoelectronic circuit 208, which are then transmitted into a conventional electronic device 300.

While the invention has been shown and described with reference to a particular embodiment thereof, it will be understood to those skilled in the art, that various changes in form and details may be made therein without departing from the spirit and scope of the invention.

I claim:

1. An optical fiber cable, comprising:
an optic fiber;
a coupler housing configured to detachably mate mechanically with a conventional electronic device;
an optoelectronic circuit embedded within said coupler housing, said optoelectronic circuit sends or receives optical signals via said optic fiber, said optoelectronic circuit configured to detachably mate electrically with a conventional electronic device.

2. The optical fiber cable of claim 1, wherein said optoelectronic circuit is fixed to said optic fiber cable and cannot be detached.

3. The optical fiber cable of claim 1, wherein an end of said optic fiber has an optical connection with said optoelectronic circuit, wherein the end of said optic fiber is encapsulated within said coupler housing.

4. The optical fiber cable of claim 1, wherein said optoelectronic circuit is encapsulated within said coupler housing.

5. The optical fiber cable of claim 4, further comprising a controller electrically connected to said optoelectronic circuit, wherein said controller is encapsulated within said coupler housing.

6. The optical fiber cable of claim 5, further comprising a pair of electrical connectors configured to detachably mate electrically with a conventional electronic device, wherein said pair of electrical connectors are connected to said controller.

7. The optical fiber cable of claim 5, further comprising a rear cable connector configured to mate with an optical fiber cable, wherein said optical fiber cable sends optical signals into said optic fiber, which are then converted to electrical signals by said optoelectronic circuit, which are then transmitted into a conventional electronic device.
